(19) United States
(12) Patent Application Publication
(10) Pub. No.: US 2021/0276622 A1
(43) Pub. Date: Sep. 9, 2021

(54) SIDE RAIL WALLS FOR BENDING LOADING IN THE EVENT OF A LATERAL IMPACT

(71) Applicant: PSA AUTOMOBILES SA, Poissy (FR)

(72) Inventors: Stéphane FONFREDE, BELFORT (FR); Tou THOR, PONT DE ROIDE VERMONDANS (FR)

(21) Appl. No.: 17/257,446

(22) PCT Filed: Jun. 14, 2019
(86) PCT No.: PCT/FR2019/051443

§ 371 Date: Dec. 31, 2020

(30) Foreign Application Priority Data
Jul. 18, 2018 (FR) 1856652

(51) Int. Cl. B62D 21/15

(52) U.S. Cl. CPC B62D 21/157

(57) ABSTRACT

The invention relates to a motor vehicle underbody structure (1) which comprises a floor (3) delimited on each side by an underbody profiled section (5), there being at least one transverse partition (13) inside at least one of the two profiled sections (7). This partition (13) or at least one of the transverse partitions (13) also has an inner edge (13.1) and an outer edge (13.2), the outer edge (13.2) having a minimum height greater than a minimum height of the inner edge (13.1), so as to generate a bending torque at the floor (3) about a longitudinal direction in the event of a side impact.

### CROSS-REFERENCE TO RELATED APPLICATIONS

This application is the US National Stage under 35 USC § 371 of International Application No. PCT/FR2019/051443, filed 14 Jun. 2019 which claims priority to French Application No. 1856652 filed 18 Jul. 2018, both of which are incorporated herein by reference.

### BACKGROUND

The invention relates to the field of motor vehicles, in particular to the problem of absorption of a side impact by a motor vehicle.

The underbody structure of motor vehicles typically comprises a floor delimited by underbody profiled sections or lateral side rails, between which there are generally front seat crossmembers which frame a central tunnel and serve to secure the front seats to the floor. In the event of a side impact with a pole, these front seat crossmembers play a fundamental role because, together with the lateral side rails, they contribute to the rigidity of the underbody structure and in particular to the absorption of the energy of the side impact on the side rails by forming a path for the passage of the forces of the latter.

In order to improve the safety of the passengers in the event of a side impact, it is therefore desirable that the seat crossmembers absorb the energy of the impact as efficiently as possible. In this regard, partitions are generally arranged transversely inside the lateral side rails and facing the seat crossmembers. These partitions usually have a rectangular shape and vertically occupy half of the cross section of the side rails. This is the case, for example, in published patent document FR 3 027 274 A1, which discloses an underbody structure with lateral side rails having half-partitions located opposite the front seat crossmember and in front of an inverted U-shaped stiffener.

In this teaching, the shape and positioning of these rectangular partitions or half-partitions in the lateral side rails in fact allows homogeneous loading of the path for the passage of the forces of the side rails over the entire height of the adjacent front seat crossmember during a side impact, and thus allows deformation of the latter to be prevented or limited. However, such a configuration aimed at maintaining the stability of the seat square has the effect of heavily loading and thus of deforming the central tunnel.

Nevertheless, in some situations it may be difficult and/or undesirable to ensure controlled loading of the seat crossmember in its axis. This may in be the case in particular with underbody structures having low seats, and therefore low front seat crossmembers. Indeed, when the lateral side rails of vehicles with low front seats are fitted with rectangular partitions or half-partitions, as previously described, the loading of the path for the force of the side rails over the front seat crossmember may inadvertently occur outside the horizontal axis of the crossmember, or the offset of the loading over the front seat crossmember may be insufficient. It may then be the case that the offset loading of the forces then generates uncontrolled bending or buckling of the crossmember.

### BRIEF SUMMARY

The object of the invention is to overcome at least one of the drawbacks of the above-mentioned prior art. In particular, the object of the invention is to improve the safety of passengers in the event of a side impact on vehicles by ensuring controlled absorption and transmission of force.

To this end, to a motor vehicle underbody structure is disclosed, the motor vehicle underbody structure comprising a floor, an underbody profiled section on each side of the floor, and at least one transverse partition in at least one of the two underbody profiled sections, wherein the or at least one of the transverse partitions has an inner edge and an outer edge, the outer edge having a minimum height greater than a minimum height of the inner edge, so as to generate a bending torque at the floor about a longitudinal direction in the event of a side impact.

The concepts of “inner” and “outer” for the edges of the transverse partitions are understood to be transverse to the vehicle.

According to an advantageous embodiment, the inner and outer edges of the transverse partition(s) are vertical and/or have an average inclination of less than 30° with respect to the vertical.

According to an advantageous embodiment, each of the two underbody profiled sections comprises an inner side rail and an outer side rail secured to the inner side rail, the inner edge of the or each of the transverse partitions facing the corresponding inner side rail and the outer edge of the or each of the transverse partitions facing the corresponding inner side rail.

According to an advantageous embodiment, the minimum height of the outer edge of the or each of the transverse partitions is greater than half the height of the inner edge.

According to an advantageous embodiment, the outer edge of the or each of the transverse partitions has a maximum height greater than a maximum height of the inner edge.

According to an advantageous embodiment, the or each of the transverse partitions has a lower edge connecting the inner and outer edges, the lower edge being inclined and/or curved.

According to an advantageous embodiment, the or each of the transverse partitions has one or more horizontal ribs.

According to an advantageous embodiment, the structure further comprises at least one seat crossmember and/or a heel board, the or at least two of the transverse partitions being located longitudinally at the height of the seat crossmember or the heel board.

According to an advantageous embodiment, the outer edge of the or each of the transverse partitions has a maximum height greater than a maximum height of the seat crossmember or the heel board adjacent to the partition.

According to an advantageous embodiment, the transverse partitions form one or more pairs of the partitions, which are arranged in parallel with one another and are connected at their outer edges.

The transverse partitions are advantageous in that they make it possible to easily reinforce the safety of passengers of motor vehicles having low front seats. The geometry of the transverse partitions makes it possible, during a side impact, to control the bending of the floor about a horizontal axis. These transverse partitions are also all the more advantageous in that they are also simple, economical and easy to implement.

### DESCRIPTION OF THE FIGURES

Other features and advantages of the present invention will be better understood with the aid of the description and the drawings, in which:

FIG. 1 is a cross section of a portion of an underbody structure of a motor vehicle with a transverse partition;

FIG. 2 is a front view of three transverse partitions; and

FIG. 3 is a perspective view from above of a portion of a motor vehicle underbody structure with a pair of transverse partitions.

### DETAILED DESCRIPTION

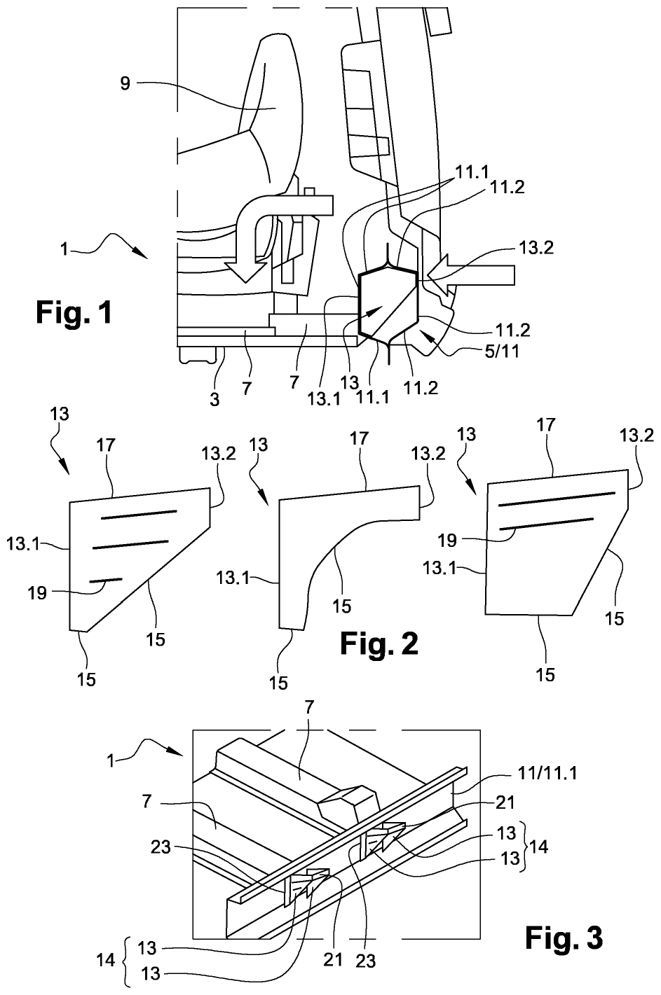

FIG. 1 is a cross section of a portion of a motor vehicle underbody structure 1, more particularly the left part. The underbody structure 1 comprises, among other things, a floor 3 of which the lateral sides are each delimited by an underbody profiled section 5, and which is overhung at least by a front seat crossmember 7 to which a front seat 9 is secured. The two underbody profiled sections 5 in fact each form a lateral side rail 11, which side rails 11 generally comprise an inner part and an outer part, commonly referred to as the inner side rail 11.1 and outer side rail 11.2, respectively, and which are interconnected at their ends. There is at least one transverse partition 13 inside at least one of the two lateral side rails 11. As shown in FIG. 1, it is the side rail 11 on the left-hand side of the vehicle underbody structure 1 which contains at least one transverse partition 13. This lateral side rail partition 13 is preferably arranged vertically in the lateral side rail 11, but it can also have an average inclination of less than 30° with respect to the vertical. In particular, it has an inner edge 13.1 and an outer edge 13.2 which are respectively, vis-à-vis, along the inner side rail 11.1 and the outer side rail 11.2. This lateral side rail partition 13 is further distinguished substantially by an outer edge 13.2 which has a minimum height, or lower end, greater than a minimum height, or lower end, of the inner edge 13.1, this having the effect of generating a bending torque at the floor 3 about a longitudinal direction in the event of a side impact, making it possible to initiate a bending deformation of the seat crossmember and thus to dampen the side impact and the deformation of the floor (see arrows in FIG. 1).

Preferably, one or more transverse partitions 13 are in fact arranged at the height of at least one low front seat crossmember 7 or at least one heel board. In this position, the outer edge 13.2 of the or each of the transverse partitions 13 has a maximum height greater than a maximum height of the front seat crossmember 7 or the adjacent heel board. Advantageously, the inner edge 13.1 of the or each of the transverse partitions 13 generally has a maximum height which is at least twice the height of the adjacent crossmember 7. This arrangement of the transverse partitions 13, as well as their shape which is asymmetric and raised relative to the low seat crossmember(s) 7, means that, in the event of a side impact, the forces of the side rail 11 are not loaded in the horizontal axis of the front seat crossmember 7, but in an offset manner and, in this case, in a manner promoting the bending of the front seat crossmember 7 toward the bottom of the underbody structure 1 (bending not shown in FIG. 1).

FIG. 2 is a front view of three transverse partitions 13. As was mentioned above (FIG. 1), the outer edge 13.2 of these transverse partitions 13 has a minimum height greater than a minimum height of the inner edge 13.1, and this minimum height of the outer edge 13.2 is also advantageously greater than half the height of the inner edge 13.1. Likewise, the outer edge 13.2 has a maximum height greater than a maximum height of the inner edge 13.1.

At the same time, and as shown in FIG. 2, the outer edge 13.2 and the inner edge 13.1 of the transverse partitions 13 are preferentially interconnected by a lower edge 15 which may be inclined and/or curved.

These transverse partitions 13 therefore have a partially triangular asymmetric shape with a greater amount of material on the inner edge 13.1, allowing these transverse partitions 13 to have, in the event of a side impact, a level of lateral force absorption on the outer side which is greater than the level of force transmission in question to the seat crossmember and/or heel board on the inner side.

Advantageously, one or each of the transverse partitions 13 has one or more horizontal ribs 19. The presence of these ribs 19 also has the effect of providing increased stiffness between the inner 13.1 and outer 13.2 edges.

FIG. 3 is a perspective view from above of a portion of a motor vehicle underbody structure 1 with transverse partitions 13 which are arranged in parallel with one another and are connected at their outer edge 13.2 (see FIG. 2) by a profiled section 21. These transverse partitions 13 form two pairs 14 of partitions 13 which are each arranged in this case at the height of and opposite a low front seat crossmember 7. They are generally formed by 1 to 2 mm thick stamped steel or aluminum parts, and are generally secured by securing lugs 23 welded inside the lateral side rails 11, as shown in FIG. 3. The securing lugs 23 are secured to the inner side rail 11.1.

In general, the transverse partitions makes it possible to reinforce the underbody structures by controlling the deformation thereof. The geometry and arrangement of the transverse partitions secured longitudinally in the lateral side rails and in particular at the height of the seat crossmembers offers the advantage, in the event of a side impact, of better controlling the chronology of the loading of forces along the side rails and over the seat crossmembers.

1. A motor vehicle underbody structure, comprising:
a floor;
two underbody profiled sections, there being one of said two underbody profiled sections on each side of the floor;
at least one transverse partition in at least one of the two underbody profiled sections;
wherein
the least one of the transverse partition has an inner edge and an outer edge, the outer edge having a minimum height greater than a minimum height of the inner edge, so as to generate a bending torque at the floor about a longitudinal direction in the event of a side impact.

2. The underbody structure according to claim 1, wherein the inner and outer edges of the at least one transverse partition are vertical and/or have an average inclination of less than 30° relative to the vertical.

3. The underbody structure according to claim 1, wherein each of the two underbody profiled sections comprises an inner side rail and an outer side rail secured to said inner side rail, the inner edge of the at least one transverse partition facing the inner side rail and the outer edge of the at least one transverse partition facing the inner side rail.

4. The underbody structure according to claim 1, wherein the minimum height of the outer edge of the at least one transverse partition is greater than half the height of the inner edge.

5. The underbody structure according to claim 1, wherein the outer edge of the at least one transverse partition has a maximum height greater than a maximum height of the inner edge.

6. The underbody structure according to claim 1, wherein the at least one transverse partition has a lower edge connecting the inner and outer edges, said lower edge being inclined and/or curved.

7. The underbody structure according to claim 1, wherein the at least one transverse partition has one or more horizontal ribs (19).

8. The underbody structure according to claim 1, wherein said underbody structure further comprises at least one seat crossmember and/or a heel board, at least two of the transverse partitions being located longitudinally at the height of the seat crossmember or the heel board.

9. The underbody structure according to claim 8, wherein the outer edge of the or each of the transverse partition has a maximum height greater than a maximum height of the seat crossmember or the heel board adjacent to said partition.

10. The underbody structure according to claim 1, wherein the at least one transverse partition forms one or more pairs of said partitions the partitions of the one or more pairs of partitions being are arranged in parallel with one another and are connected at their outer edges.
